(19) United States
(12) Patent Application Publication
(10) Pub. No.: US 2019/0285924 A1
(43) Pub. Date: Sep. 19, 2019

(54) LIQUID CRYSTAL DISPLAY DEVICE

(71) Applicant: SHARP KABUSHIKI KAISHA, Sakai City (JP)

(72) Inventors: TAKAKO KOIDE, Sakai City (JP); AKIRA SAKAI, Sakai City (JP); MASAHIRO HASEGAWA, Sakai City (JP); YUICHI KAWAHIRA, Sakai City (JP); KOJI MURATA, Sakai City (JP); KIYOSHI MINOURA, Sakai City (JP)

(21) Appl. No.: 16/297,368

(22) Filed: Mar. 8, 2019

(30) Foreign Application Priority Data
Mar. 13, 2018 (JP) 2018-045609

(51) Int. Cl. G02F 1/13363; G02F 1/1335; G02F 1/1337; G02F 1/1368; G02F 1/1339

(52) U.S. Cl. CPC G02F 1/13363; G02F 1/133528; G02F 1/1337; G02F 1/1368; G02F 1/133514; G02F 1/13394; G02F 2413/02; G02F 2413/06; G02F 2001/133519; G02F 2001/133633; G02F 2202/28; G02F 2001/13398; G02F 2001/133638

(57) ABSTRACT

The present invention provides a liquid crystal display device configured to prevent impurities in a retardation layer in a liquid crystal cell from dissolving into a liquid crystal layer, achieving excellent reliability. The liquid crystal display device including, in the following order from a viewing surface side toward a back surface side: a first polarizing plate; a first λ/4 retardation layer; a supporting substrate; a second λ/4 retardation layer; a first overcoat layer; an alignment film; a liquid crystal layer containing liquid crystal molecules horizontally aligned with no voltage applied; a TFT substrate including a pair of electrodes configured to generate a transverse electric field in the liquid crystal layer upon voltage application; and a second polarizing plate.

### CROSS-REFERENCE TO RELATED APPLICATIONS

The present application claims priority under 35 U.S.C. § 119 to Japanese Patent Application No. 2018-045609 filed on Mar. 13, 2018, the contents of which are incorporated herein by reference in their entirety.

### BACKGROUND OF THE INVENTION

### Field of the Invention

The present invention relates to liquid crystal display devices. More specifically, the present invention relates to a liquid crystal display device including a retardation layer in a liquid crystal cell.

### Description of Related Art

Liquid crystal display devices are display devices utilizing a liquid crystal composition to provide display. A typical display method therefor includes irradiating a liquid crystal cell (liquid crystal display panel) enclosing a liquid crystal composition between a pair of substrates with light from a backlight, and applying voltage to the liquid crystal composition to change the alignment of the liquid crystal molecules, thereby controlling the amount of light transmitted through the liquid crystal cell. Such a liquid crystal display device, having features including a thin profile, light weight, and low power consumption, is used in electronic devices such as televisions, smartphones, tablet computers, and automotive navigation systems. Some such liquid crystal display devices include a retardation film used to prevent external light reflection, color compensation, and viewing angle compensation, for example.

A conventional liquid crystal display device, when used in a bright place such as outdoors, may have low display quality due to a low contrast ratio under the influence of external light reflected on the inside and surface of the liquid crystal display device. The external light reflectance can be decreased and thus the outdoor visibility can be enhanced by bonding a retardation film to the viewing surface side of the liquid crystal cell. Meanwhile, for reduction in thickness and the number of members of a liquid crystal display device, the liquid crystal display device is desired to include a retardation layer in the liquid crystal cell (such a retardation layer is also referred to as an “in-cell retardation layer”) in place of the retardation film bonded to the liquid crystal cell. The in-cell retardation layer can be, for example, one obtained by stacking a retardation film containing a reactive mesogen on an alignment film.

One of the prior art documents disclosing provision of an in-cell retardation layer is JP 2008-83492 A, for example. JP 2008-83492 A discloses that a liquid crystal display device operating in a transverse electric field operation mode includes: a conductive layer to prevent a decrease in the display quality due to static electricity; a first retardation layer provided on the conductive layer to reduce reflection of light on the conductive layer; and a second retardation layer provided closer to the liquid crystal layer than the first retardation layer is, to change the polarized light control condition achieved by the first retardation layer.

### BRIEF SUMMARY OF THE INVENTION

Studies and development on in-cell retardation layers have been made. The studies made by the present inventors revealed that the structure in which the second retardation layer in the liquid crystal cell is in direct contact with the alignment film as shown in FIG. 7 of JP 2008-83492 A allows impurities in the retardation layer to dissolve into the liquid crystal layer, decreasing the reliability.

In response to these issues, an object of the present invention is to provide a liquid crystal display device configured to prevent impurities in the retardation layer in the liquid crystal cell from dissolving into the liquid crystal layer, achieving excellent reliability.

The present inventors focused on the technique of disposing a retardation layer (in-cell retardation layer) in the liquid crystal cell and made intensive studies on the technique. The studies found that impurities in the in-cell retardation layer can permeate through the alignment film to dissolve into the liquid crystal layer, decreasing the reliability. The inventors found that such dissolution of impurities is preventable by disposing an overcoat layer between the in-cell retardation layer and the alignment film. Thereby, the inventors successfully achieved the above object, completing the present invention.

In other words, one aspect of the present invention is directed to a liquid crystal display device including, in the following order from a viewing surface side toward a back surface side: a first polarizing plate; a first λ/4 retardation layer; a supporting substrate; a second λ/4 retardation layer; a first overcoat layer; an alignment film; a liquid crystal layer containing liquid crystal molecules horizontally aligned with no voltage applied; a TFT substrate including a pair of electrodes configured to generate a transverse electric field in the liquid crystal layer upon voltage application; and a second polarizing plate.

The present invention can provide a liquid crystal display device configured to prevent impurities in a retardation layer in a liquid crystal cell from dissolving into a liquid crystal layer, achieving excellent reliability.

### BRIEF DESCRIPTION OF THE DRAWINGS

FIG. 1A is a schematic cross-sectional view of a liquid crystal display device of Embodiment 1, and FIG. 1B is a schematic cross-sectional view showing an exemplary structure of a TFT substrate.

FIG. 2 is a schematic cross-sectional view of a liquid crystal display device of Embodiment 2.

FIG. 3 is a graph showing changes in voltage holding ratio (VHR) of liquid crystal display devices of Comparative Examples 1 and 2 and Example 1 in a reliability test.

FIG. 4 is a schematic cross-sectional view of a liquid crystal display device of Example 2.

FIG. 5 is a schematic cross-sectional view of a liquid crystal display device of Example 3.

FIG. 6 is a schematic cross-sectional view of a liquid crystal display device of Example 4.

FIG. 7 is a schematic cross-sectional view of a liquid crystal display device of Example 5.

FIG. 8 is a schematic cross-sectional view of a liquid crystal display device of Example 6.

FIG. 9 is a schematic cross-sectional view of a liquid crystal display device of Example 7.

FIG. 10 is a schematic cross-sectional view of a liquid crystal display device of Example 8.

FIG. 11 is a schematic cross-sectional view of a liquid crystal display device of Comparative Example 1.

FIG. 12 is a schematic cross-sectional view of a liquid crystal display device of Comparative Example 2.

FIG. 13A is a view showing the state where a thin film of a photosensitive material is formed on a first overcoat layer 26.

FIG. 13B is a view illustrating how to expose the thin film of a photosensitive material to light.

FIG. 13C is a view showing the state where photo spacers are formed on the first overcoat layer 26.

FIG. 14 is a schematic cross-sectional view of a structure in which the liquid crystal display device of Comparative Example 2 includes photo spacers.

FIG. 15 is an enlarged view from FIG. 14 illustrating exudation of a developer adhering to photo spacers 203.

FIG. 16 is a schematic cross-sectional view of a structure in which the liquid crystal display device of Embodiment 1 includes photo spacers.

FIG. 17 is an enlarged view from FIG. 16 illustrating exudation of a developer adhering to the photo spacers 203.

FIG. 18 is a schematic cross-sectional view of a structure in which the liquid crystal display device of Embodiment 2 includes photo spacers.

### DETAILED DESCRIPTION OF THE INVENTION

The present invention is described in more detail based on the following embodiments with reference to the drawings. The embodiments, however, are not intended to limit the scope of the present invention. The configurations of the embodiments may appropriately be combined or modified within the spirit of the present invention.

### Definition

The “viewing surface side” as used herein means the side closer to the screen (display surface) of the liquid crystal display device, and the “back surface side” means the side farther from the screen (display surface) of the display device.

The “retardation layer” as used herein means a retardation layer providing an in-plane retardation of 10 nm or more to at least light having a wavelength of 550 nm. Light having a wavelength of 550 nm is light of a wavelength at which a human has the highest visual sensitivity. The in-plane retardation is defined as R=(ns−nf)×d, where ns represents the in-plane principal refractive index nx or ny of the retardation layer, whichever is greater, nf represents the in-plane principal refractive index nx or ny of the retardation layer, whichever is smaller, and d represents the thickness of the retardation layer. The principle refractive indexes are values for light having a wavelength of 550 nm, unless otherwise stated. The in-plane slow axis of a retardation layer means an axis extending in the direction corresponding to ns, and the in-plane fast axis thereof means an axis extending in the direction corresponding to nf. The “retardation” as used herein means the in-plane retardation, unless otherwise stated.

The “λ/4 retardation layer” as used herein means a retardation layer providing an in-plane retardation of ¼ wavelength (137.5 nm) to at least light having a wavelength of 550 nm, and may be any retardation layer providing an in-plane retardation of 100 nm or more and 176 nm or less.

### Embodiment 1

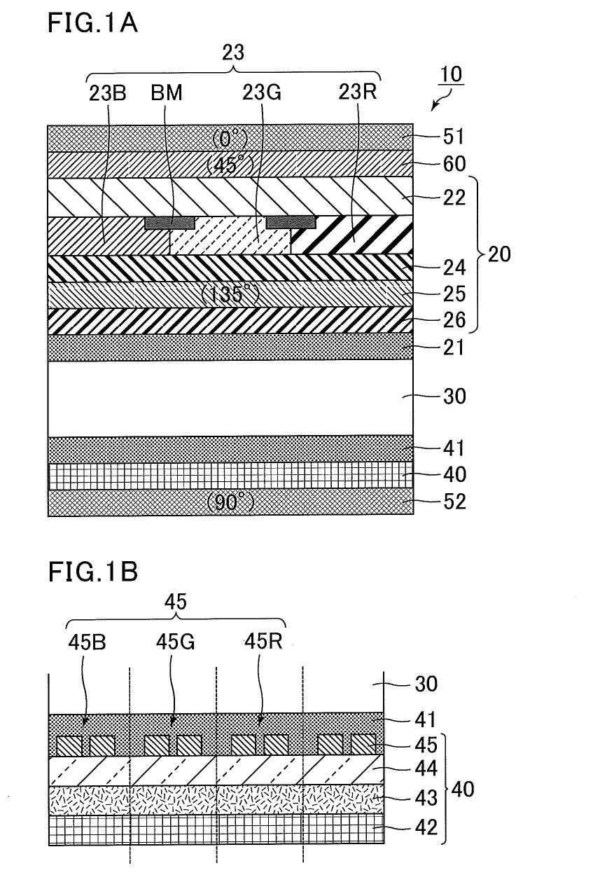

FIG. 1A is a schematic cross-sectional view of a liquid crystal display device of Embodiment 1, and FIG. 1B is a schematic cross-sectional view showing an exemplary structure of a TFT substrate. As shown in FIG. 1A, a liquid crystal display device 10 of Embodiment 1 includes, in the following order from the viewing surface side toward the back surface side, a first polarizing plate 51, a first λ/4 retardation layer 60, a color filter substrate 20, a first alignment film 21, a liquid crystal layer 30, a second alignment film 41, a TFT substrate 40, and a second polarizing plate 52. In the case of a transmissive or transflective liquid crystal display device, a backlight (not illustrated) configured to irradiate the liquid crystal layer 30 with light is disposed on the back surface side of the second polarizing plate 52. The first λ/4 retardation layer 60, disposed outside the liquid crystal cell (closer to the viewing surface side than a supporting substrate 22 is), is also called an “out-cell retardation layer”.

The first polarizing plate 51 and the second polarizing plate 52 can be, for example, a polarizer (absorptive polarizing plate) obtained by dyeing a polyvinyl alcohol (PVA) film with an anisotropic material such as an iodine complex (or a dye) to adsorb the material on the PVA film and stretch-aligning the material. Typically, in order to achieve a mechanical strength and moist heat resistance, each surface of the PVA film is laminated with a protective film such as a triacetyl cellulose (TAC) film for practical use.

The first polarizing plate 51 and the second polarizing plate 52 are preferably disposed such that their transmission axes are perpendicular to each other. The first polarizing plate 51 and the second polarizing plate 52 in this structure are disposed in crossed Nicols, and thereby can achieve favorable black display with no voltage applied. Hereinafter, description is made based on the definition that the transmission axis of the first polarizing plate 51 is defined to be at an azimuth of 0°. Here, the transmission axis of the second polarizing plate 52 is preferably at an azimuth of 90°.

The first λ/4 retardation layer (out-cell retardation layer) 60 in combination with the first polarizing plate 51 functions as a circularly polarizing plate. This can reduce internal reflection in the liquid crystal display device 10, reducing reflection (glare) of external light. The liquid crystal display device therefore can provide display with a high contrast ratio even in a bright environment with strong external light.

The out-cell retardation layer 60 may be formed from any material. Yet, the out-cell retardation layer 60 can be formed on the color filter substrate 20 by bonding, and thus a stretched polymer film (retardation film) generally used in the field of liquid crystal display devices is preferred. The polymer film may be formed from, for example, a cycloolefin polymer, polycarbonate, polysulfone, polyethersulfone, polyethylene terephthalate, polyethylene, polyvinyl alcohol, norbornene, triacetyl cellulose, or diacetyl cellulose, particularly preferably from a cycloolefin polymer. A retardation layer formed from a cycloolefin polymer has advantages including excellent durability and small retardation changes in long-term exposure to a high-temperature environment or a high-temperature, high-humidity environment.

The out-cell retardation layer 60 can also be formed from a photo-polymerizable liquid crystal material as with the later-described in-cell retardation layer 25. The out-cell retardation layer 60 can be formed from a photo-polymerizable liquid crystal material by a method including coating a flat base film such as a PET film with the photo-polymerizable liquid crystal material to form a film, transferring the obtained film onto the first polarizing plate 51 or the color filter substrate 20 via a curable adhesive or a pressure-sensitive adhesive, and removing the base film, or a method including coating the outside (surface on the viewer's side) of the color filter substrate 20 directly with the photo-polymerizable liquid crystal material to form a film.

The color filter substrate 20 includes, in the following order from the viewing surface side toward the back surface side, the supporting substrate 22, a color filter layer 23, a second overcoat layer 24, the second λ/4 retardation layer 25, and a first overcoat layer 26. The second λ/4 retardation layer 25, formed inside the liquid crystal cell (closer to the back surface than the supporting substrate 22 is), is also referred to as an “in-cell retardation layer”.

The supporting substrate 22 is preferably a transparent substrate. For example, a glass substrate or a plastic substrate is used.

The color filter layer 23 includes red color filters 23R, green color filters 23G, and blue color filters 23B arranged in a plane and partitioned by a black matrix BM. The red color filters 23R, the green color filters 23G, the blue color filters 23B, and the black matrix BM each are, for example, formed from a transparent resin containing a pigment. Typically, a red color filter 23R, a green color filter 23G, and a blue color filter 23B in combination are disposed in each and every pixel, and the desired color can be produced for the pixel by mixing colored lights transmitted through the red color filter 23R, the green color filter 23G, and the blue color filter 23B while controlling the amounts of the colored lights. The black matrix BM can be formed from, for example, a black photosensitive acrylic resin. The red color filters 23R, the green color filters 23G, and the blue color filters 23B may not have the same thickness. In other words, the liquid crystal layer 30 side surface of the color filter layer 23 may not be flat.

The second overcoat layer 24 covers the liquid crystal layer 30 side surface of the color filter layer 23. The second overcoat layer 24 functions to flatten the base of the in-cell retardation layer 25 when the liquid crystal layer 30 side surface of the color filter layer 23 is not flat. The second overcoat layer 24 can also prevent impurities in the color filter layer 23 from dissolving to the liquid crystal layer 30 side. The second overcoat layer 24 is preferably formed from a photocurable or heat-curable transparent resin. A photocurable transparent resin is used in combination with, for example, a photopolymerization initiator, an additive, and/or a solvent. The second overcoat layer 24 has a thickness of, for example, 0.5 to 2.0 μm, preferably 0.8 to 1.2 μm.

The second λ/4 retardation layer (in-cell retardation layer) 25 is used in combination with the out-cell retardation layer 60. In other words, a circularly polarized light transverse electric field mode liquid crystal display device including only the out-cell retardation layer 60 cannot provide black display, and therefore includes the in-cell retardation layer 25 to optically compensate for the out-cell retardation layer 60, so that these retardation layers are optically substantially absent. This gives a configuration optically equivalent to a conventional transverse electric field mode liquid crystal display device providing no circular polarization, enabling black display. The retardation values and arrangement of the axes of the out-cell retardation layer 60 and the in-cell retardation layer 25 are therefore preferably designed such that the retardation layers cancel out each other's retardation provided to light incident on the liquid crystal cell from the backlight. Also, the in-plane slow axis of the out-cell retardation layer 60 and the in-plane slow axis of the in-cell retardation layer 25 are preferably perpendicular to each other. In order to allow the retardation layer to exert its function, the in-plane slow axis of the out-cell retardation layer 60 and the in-plane slow axis of the in-cell retardation layer 25 preferably form an angle of 45° with the transmission axis of the respective first polarizing plate 51 and the transmission axis of the second polarizing plate 52. In other words, preferably, one of the in-plane slow axis of the out-cell retardation layer 60 or the in-plane slow axis of the in-cell retardation layer 25 is at an azimuth of 45° and the other is at an azimuth of 135°. For example, preferably, the in-plane slow axis of the out-cell retardation layer 60 is at an azimuth of 45° and the in-plane slow axis of the in-cell retardation layer 25 is at an azimuth of 135°.

Preferred exemplary arrangement of the optical axes in the present embodiment is shown in FIG. 1A; the transmission axis of the first polarizing plate 51 is at an azimuth of 0°, the in-plane slow axis of the out-cell retardation layer 60 is at an azimuth of 45°, the in-plane slow axis of the in-cell retardation layer 25 is at an azimuth of 135°, the liquid crystal molecules in the liquid crystal layer 30 are at an initial alignment azimuth of 0° or 90°, and the transmission axis of the second polarizing plate 52 is at an azimuth of 90°.

The in-cell retardation layer 25 is preferably formed from a cured product of a photo-polymerizable liquid crystal material (also referred to as a “reactive mesogen”). With the photo-polymerizable liquid crystal material, the in-cell retardation layer 25 can be formed by coating during the production process of the color filter substrate 20, so that the liquid crystal display device 10 can be reduced in thickness.

The process of forming the in-cell retardation layer 25 is described in detail. The in-cell retardation layer 25 is formed by coating with the photo-polymerizable liquid crystal material (reactive mesogen) and curing the material. The photo-polymerizable liquid crystal material may be a liquid crystal polymer (liquid crystalline polymer) having a photoreactive group. Examples of the photo-polymerizable liquid crystal material include polymers having a side chain including both a substituent (mesogen group) such as a biphenyl group, a terphenyl group, a naphthalene group, a phenyl benzoate group, an azobenzene group, or a derivative thereof and a photoreactive group such as a cinnamoyl group, a chalcone group, a cinnamylidene group, a β-(2-phenyl)acryloyl group, a cinnamic acid group, or a derivative thereof, and a main chain derived from an acrylate, a methacrylate, maleimide, N-phenylmaleimide, or a siloxane. The polymer may be a homopolymer containing only a single type of repeat unit, or may be a copolymer containing two or more types of repeat units with different side chain structures. The copolymer includes copolymers such as alternating copolymers, random copolymers, and graft copolymers. In each copolymer, a side chain of at least one repeat unit has a mesogen group and a photoreactive group such as those described above together, but a side chain of another repeat unit may contain no mesogen group or no photoreactive group.

The photo-polymerizable liquid crystal material may contain an additive such as a photopolymerization initiator. The photopolymerization initiator may be any conventionally used one.

Examples of the solvent used for coating with the photo-polymerizable liquid crystal material include toluene, ethylbenzene, ethylene glycol monomethyl ether, ethylene glycol dimethyl ether, propylene glycol methyl ether, dibutyl ether, acetone, methyl ethyl ketone, ethanol, propanol, cyclohexane, cyclopentanone, methylcyclohexane, tetrahydrofuran, dioxane, cyclohexanone, n-hexane, ethyl acetate, butyl acetate, propylene glycol methyl ether acetate, methoxybutyl acetate, N-methylpyrrolidone, and dimethylacetamide. These may be used alone or in combination with each other.

The in-cell retardation layer 25 can be formed from a photo-polymerizable liquid crystal material by, for example, the following method. A base alignment film is formed on the second overcoat layer 24, and is subjected to an alignment treatment such as rubbing or photoirradiation for alignment azimuth determination. The base alignment film having been subjected to the alignment treatment is coated with a photo-polymerizable liquid crystal material, which is then cured by a method such as baking or photoirradiation. The coating with a photo-polymerizable liquid crystal material can be performed suitably with an applicator such as a slit coater or a spin coater. The coating with the material is performed to give a uniform thickness, and the material is pre-baked at about 70° C. to 100° C. for two minutes. The material is then subjected to photocuring using an exposure device emitting light (ultraviolet light) having a wavelength of 313 to 365 nm. The baking temperature and photocuring conditions may be adjusted as appropriate according to the photo-polymerizable liquid crystal material, and are not limited to the above conditions.

The molecules of the cured photo-polymerizable liquid crystal material are aligned at the alignment azimuth provided by the base alignment film, so that the material functions as a retardation layer. The retardation provided by the retardation layer is typically determined as a product of the birefringence Δn of the photo-polymerizable liquid crystal material and the thickness d of the retardation layer.

In the case where the photo-polymerizable liquid crystal material itself is a material inducing the alignment by a method such as polarized ultraviolet light application, the formation of a base alignment film can be omitted.

The in-cell retardation layer 25 may also be formed from a photo-polymerizable liquid crystal material by a method including coating a base film such as a PET film with a photo-polymerizable liquid crystal material to form a film, and transferring the obtained film to the second overcoat layer 24 via an adhesive (a pressure-sensitive adhesive or a curable adhesive). In this case, the pressure-sensitive adhesive layer is disposed adjacent to the viewing surface side of the in-cell retardation layer 25.

Also, a stretched polymer film (retardation film) typically used in the field of liquid crystal display devices may be bonded to the second overcoat layer 24 via a pressure-sensitive adhesive to produce the in-cell retardation layer 25. In this case, the pressure-sensitive adhesive layer is disposed adjacent to the viewing surface side of the in-cell retardation layer 25.

The first overcoat layer 26 covers the liquid crystal layer 30 side surface of the in-cell retardation layer 25. Without the first overcoat layer 26, impurities in the photo-polymerizable liquid crystal material used for the in-cell retardation layer 25, such as the photopolymerization initiator and unreacted monomers, may exude into the first alignment film 21 or the liquid crystal layer 30. In the case where the curable adhesive or the pressure-sensitive adhesive used to transfer the in-cell retardation layer 25 is adjacent to the in-cell retardation layer 25, impurities contained in the pressure-sensitive adhesive (e.g., moisture, ions) may exude into the first alignment film 21 or the liquid crystal layer 30. Impurities, when exuding into the first alignment film 21 or the liquid crystal layer 30, unfortunately decrease the voltage holding ratio, causing display defects such as stain at sites such as the edge of the display surface. In contrast, the first overcoat layer 26 reduces exudation of impurities into the first alignment film 21 or the liquid crystal layer 30, enhancing the reliability of the liquid crystal display device. The first overcoat layer 26 is preferably formed from a photocurable or heat-curable transparent resin. The first overcoat layer 26 preferably has a thickness of 0.5 μm or greater. If the thickness is smaller than 0.5 μm, the effect of preventing exudation of impurities may be low. The first overcoat layer 26 preferably has a thickness of smaller than 3.0 μm. If the thickness is greater than 3.0 μm, parallax color mixing may occur. In formation of the first overcoat layer 26, the required time for completion of the curing reaction of the transparent resin, photocurable or heat-curable, is short enough to avoid problems, whereas in formation of the in-cell retardation layer 25, the required time may cause a problem that the process is finished with remaining unreacted products. Hence, impurities are more likely to be generated from the in-cell retardation layer 25 than from the first overcoat layer 26.

The first alignment film 21 and the second alignment film 41 have a function to control the alignment of liquid crystal molecules contained in the liquid crystal layer 30. When the voltage applied to the liquid crystal layer 30 is less than the threshold voltage (including the case of no voltage application), the first alignment film 21 and the second alignment film 41 mainly function to control the long axes of the liquid crystal molecules in the liquid crystal layer 30 to be oriented to the direction parallel to the first alignment film 21 and the second alignment film 41. The first alignment film 21 and the second alignment film 41 are layers on which the alignment treatment to control the alignment of liquid crystal molecules was performed. These alignment films can be common alignment films used in the field of liquid crystal display devices, such as a polyimide. The first alignment film 21 and the second alignment film 41 may be formed from, for example, a polymer whose main chain is derived from a polyimide, a polyamic acid, or a polysiloxane. Preferred is a photoalignment film material having a photoreactive site (functional group) in its main chain or side chain.

The liquid crystal layer 30 contains liquid crystal molecules horizontally aligned with no voltage applied. The liquid crystal layer 30, when voltage is applied thereto, changes the alignment state of the liquid crystal molecules in response to the applied voltage, thereby controlling the transmission amount of light. The liquid crystal molecules in the liquid crystal layer 30 are horizontally aligned by the control force of the first alignment film 21 and the second alignment film 41 when no voltage is applied between the pair of electrodes (with no voltage applied) in the TFT substrate 40. In contrast, the liquid crystal molecules rotate in an in-plane direction in response to the transverse electric fields generated in the liquid crystal layer 30 when voltage is applied between the pair of electrodes (with voltage applied).

The anisotropy of dielectric constant (Δε) of the liquid crystal molecules defined by the following formula may be positive or negative.

Δε=(dielectric constant in long-axis direction)−(dielectric constant in short-axis direction)

The TFT substrate 40 is a substrate including thin film transistors (TFTs), which are switching elements used to switch between the ON and OFF states of the respective pixels in the liquid crystal display device, as well as other members such as conductive lines and electrodes connected to the TFTs, and an insulating film electrically separating these members.

The TFT substrate 40 includes a pair of electrodes configured to generate a transverse electric field in the liquid crystal layer 30 when voltage is applied thereto. The liquid crystal display device of the present embodiment may be driven in a liquid crystal drive mode such as the fringe field switching (FFS) mode or the in-plane switching (IPS) mode, although FIG. 1B shows the structure of the FFS mode TFT substrate.

As shown in FIG. 1B, the TFT substrate 40 includes a supporting substrate 42, a common electrode (planar electrode) 43 disposed on the liquid crystal layer 30 side surface of the supporting substrate 42, an insulating film 44 covering the common electrode 43, and pixel electrodes (comb electrodes) 45 disposed on the liquid crystal layer 30 side surface of the insulating film 44. With this structure, a transverse electric field (fringe electric field) can be generated in the liquid crystal layer 30 by applying voltage between the common electrode 43 and each pixel electrode 45, which constitute a pair of electrodes. Thus, the alignment of liquid crystal molecules in the liquid crystal layer 30 can be controlled by adjusting the voltage to be applied between the common electrode 43 and the pixel electrode 45. The pixel electrodes 45 each include a red pixel electrode 45R, a green pixel electrode 45G, and a blue pixel electrode 45B so as to enable individual control of the amounts of colored lights to be transmitted through the red color filter 23R, the green color filter 23G, and the blue color filter 23B, respectively.

The supporting substrate 42 may be, for example, a glass substrate or a plastic substrate. The common electrode 43 and the pixel electrodes 45 may each be formed from, for example, indium tin oxide (ITO) or indium zinc oxide (IZO). The insulating film 44 may be formed from, for example, an organic insulating film or a nitride film.

The case is described above where the TFT substrate 40 is an FFS mode TFT substrate. An IPS mode TFT substrate, which is also a substrate for the transverse electric field mode, includes a pair of electrodes, namely a comb electrode for the common electrode and comb electrodes for the pixel electrodes. Applying voltage between the pair of comb electrodes generates a transverse electric field in the liquid crystal layer 30, thereby controlling the alignment of liquid crystal molecules in the liquid crystal layer 30.

The liquid crystal display device 10 may include other members such as an anti-reflection film disposed on the viewing surface side of the first polarizing plate 51, which enables further reduction of internal reflection in the liquid crystal display device 10. The anti-reflection film is preferably a moth-eye film having a surface structure resembling a moth's eye.

A transparent electrode may be disposed on the viewing surface side of the color filter substrate 20. Such a transparent electrode enables prevention of defects due to charging. Also, a sensor for a touch panel may be disposed on the viewing surface side of the color filter substrate 20.

### Embodiment 2

A liquid crystal display device of Embodiment 2 has the same structure as the liquid crystal display device of Embodiment 1, except that no second overcoat layer is formed. The liquid crystal display device of Embodiment 2, including no second overcoat layer, requires a less number of production processes than the liquid crystal display device of Embodiment 1, enhancing the productivity.

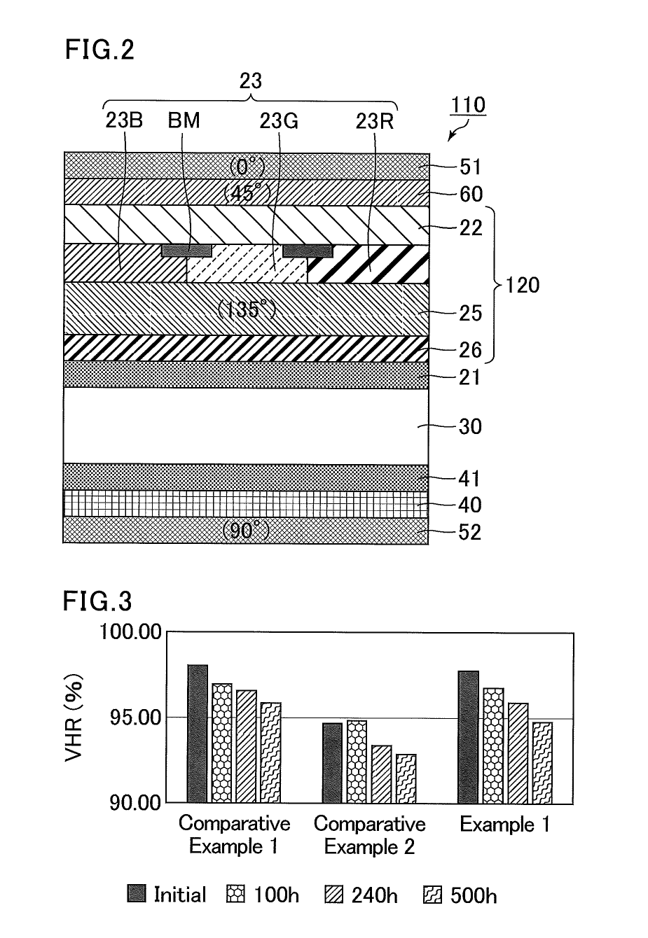

FIG. 2 is a schematic cross-sectional view of a liquid crystal display device of Embodiment 2. As shown in FIG. 2, a liquid crystal display device 110 of Embodiment 2 includes, in the following order from the viewing surface side toward the back surface side, the first polarizing plate 51, the first λ/4 retardation layer 60, a color filter substrate 120, the first alignment film 21, the liquid crystal layer 30, the second alignment film 41, the TFT substrate 40, and the second polarizing plate 52. The color filter substrate 120 includes, in the following order from the viewing surface side toward the back surface side, the supporting substrate 22, the color filter layer 23, the second λ/4 retardation layer 25, and the first overcoat layer 26.

The liquid crystal display device 110 of Embodiment 2 includes the color filter layer 23 and the second λ/4 retardation layer (in-cell retardation layer) 25 in direct contact with each other. As described above, since the second λ/4 retardation layer 25 can be formed by coating, the second λ/4 retardation layer 25 formed by coating can flatten the liquid crystal layer 30 side surface of the color filter layer 23 even when the surface is not flat.

### (1) Reliability Evaluation

The reliability evaluation was performed in the following Comparative Examples 1 and 2 and Example 1.

### Comparative Example 1

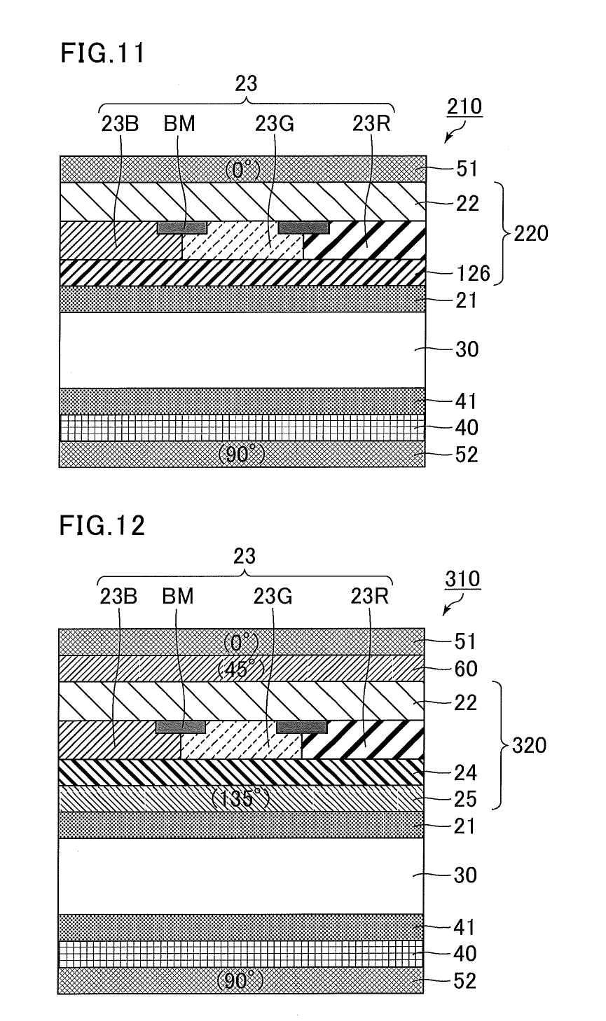

FIG. 11 is a schematic cross-sectional view of a liquid crystal display device of Comparative Example 1. As shown in FIG. 11, a liquid crystal display device 210 of Comparative Example 1 includes, in the following order from the viewing surface side toward the back surface side, the first polarizing plate 51, a color filter substrate 220, the first alignment film 21, the liquid crystal layer 30, the second alignment film 41, the FFS mode TFT substrate 40, and the second polarizing plate 52. The color filter substrate 220 includes, in the following order from the viewing surface side toward the back surface side, the supporting substrate 22, the color filter layer 23, and an overcoat layer 126.

The liquid crystal display device 210 of Comparative Example 1, including no first λ/4 retardation layer (out-cell retardation layer) and no second λ/4 retardation layer (in-cell retardation layer), cannot reduce the reflection caused by members such as the black matrix BM in the liquid crystal display device 210. This causes external light reflection in a bright place, decreasing the display visibility.

### Comparative Example 2

FIG. 12 is a schematic cross-sectional view of a liquid crystal display device of Comparative Example 2. As shown in FIG. 12, a liquid crystal display device 310 of Comparative Example 2 includes, in the following order from the viewing surface side toward the back surface side, the first polarizing plate 51, the first λ/4 retardation layer 60, a color filter substrate 320, the first alignment film 21, the liquid crystal layer 30, the second alignment film 41, the FFS mode TFT substrate 40, and the second polarizing plate 52. The color filter substrate 320 includes, in the following order from the viewing surface side toward the back surface side, the supporting substrate 22, the color filter layer 23, the second overcoat layer 24, and the second λ/4 retardation layer 25.

The liquid crystal display device 310 of Comparative Example 2, including the first λ/4 retardation layer (out-cell retardation layer) 60 and the second λ/4 retardation layer (in-cell retardation layer) 25, can reduce reflection caused by members such as the black matrix BM in the liquid crystal display device 310, preventing a decrease in the display visibility due to external reflection in a bright place. Yet, since the in-cell retardation layer 25 is in contact with the first alignment film 21, impurities in the photo-polymerizable liquid crystal material used for the in-cell retardation layer 25 exude into the first alignment film 21 and/or the liquid crystal layer 30, which causes display defects due to a decrease in the voltage holding ratio.

### Example 1

A liquid crystal display device of Example 1 has the same structure as the liquid crystal display device of Embodiment 1 shown in FIG. 1. The liquid crystal drive mode is the FFS mode. The in-cell retardation layer 25 was formed by coating. The liquid crystal display device of Example 1, including the first overcoat layer between the in-cell retardation layer and the first alignment film, can prevent display defects due to a decrease in the voltage holding ratio unlike in the liquid crystal display device of Comparative Example 2.

### (Evaluation Results)

The liquid crystal display devices of Comparative Examples 1 and 2 and Example 1 were each placed in a 70° C. thermostat, and a voltage of 5 V was continuously applied to the liquid crystal display device at a frequency of 60 Hz with the backlight turned on. The voltage holding ratio (VHR) was measured by applying a voltage of 1 V at a frequency of 1 Hz at the initial stage, after 100 hours (100 h), after 240 hours (240 h), and after 500 hours (500 h). Thereby, the changes with time in the voltage holding ratio were determined. The results are shown in FIG. 3.

FIG. 3 shows that the voltage holding ratio in Comparative Example 2 was low from the initial stage and further decreased with time, eventually to 93% or less after 500 hours. In contrast, in Example 1, the initial voltage holding ratio was high as with the initial voltage holding ratio in Comparative Example 1 in which no in-cell retardation layer was used, and a voltage holding ratio of 94% or higher was maintained even after 500 h. The liquid crystal display device of Example 1 had no display defects due to a decrease in the voltage holding ratio after the reliability test, exhibiting excellent display quality.

### (2) Parallax Color Mixing Evaluation

High-definition displays have a small pixel size, and may therefore cause parallax color mixing in an oblique view of the display surface when the distance between the color filter layer and the liquid crystal layer is large. In order to determine the relationships between the thicknesses of the in-cell retardation layer and the overcoat layer and parallax color mixing, liquid crystal display devices of the following Examples 2 to 8 were subjected to parallax color mixing evaluation.

### Example 2

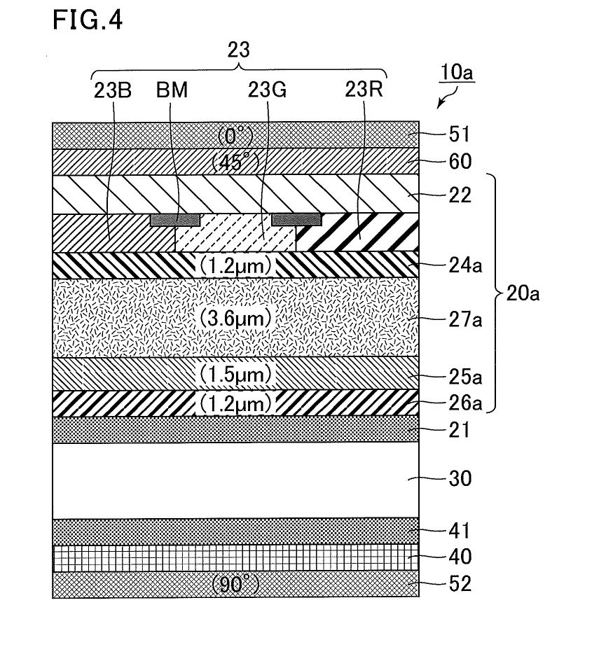

FIG. 4 is a schematic cross-sectional view of a liquid crystal display device of Example 2. As shown in FIG. 4, a liquid crystal display device 10a of Example 2 includes, in the following order from the viewing surface side toward the back surface side, the first polarizing plate 51, the first λ/4 retardation layer (out-cell retardation layer) 60, a color filter substrate 20a, the first alignment film 21, the liquid crystal layer 30, the second alignment film 41, the TFT substrate 40, and the second polarizing plate 52. The color filter substrate 20a includes, in the following order from the viewing surface side toward the back surface side, the supporting substrate 22, the color filter layer 23, a second overcoat layer 24a, a pressure-sensitive adhesive layer 27a, a second λ/4 retardation layer (in-cell retardation layer) 25a, and a first overcoat layer 26a.

In Example 2, a film-type retardation layer is used as the in-cell retardation layer 25a, and is bonded to the second overcoat layer 24a via the pressure-sensitive adhesive layer 27a. The second overcoat layer 24a had a thickness of 1.2 μm. The pressure-sensitive adhesive layer 27a had a thickness of 3.6 μm. The in-cell retardation layer 25a had a thickness of 1.5 μm. The first overcoat layer 26a had a thickness of 1.2 μm.

### Example 3

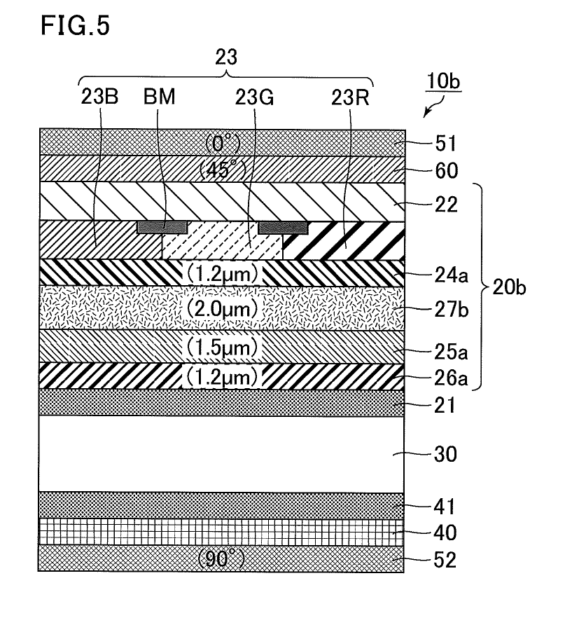

FIG. 5 is a schematic cross-sectional view of a liquid crystal display device of Example 3. As shown in FIG. 5, a liquid crystal display device 10b of Example 3 includes, in the following order from the viewing surface side toward the back surface side, the first polarizing plate 51, the first λ/4 retardation layer (out-cell retardation layer) 60, a color filter substrate 20b, the first alignment film 21, the liquid crystal layer 30, the second alignment film 41, the TFT substrate 40, and the second polarizing plate 52. The color filter substrate 20b includes, in the following order from the viewing surface side toward the back surface side, the supporting substrate 22, the color filter layer 23, the second overcoat layer 24a, a pressure-sensitive adhesive layer 27b, the second λ/4 retardation layer (in-cell retardation layer) 25a, and the first overcoat layer 26a.

In Example 3, as in Example 2, a film-type retardation layer is used as the in-cell retardation layer 25a, and is bonded to the second overcoat layer 24a via the pressure-sensitive adhesive layer 27a. The pressure-sensitive adhesive layer 27b had a smaller thickness than the pressure-sensitive adhesive layer 27a in Example 2. The pressure-sensitive adhesive layer 27b had a thickness of 2.0 μm.

### Example 4

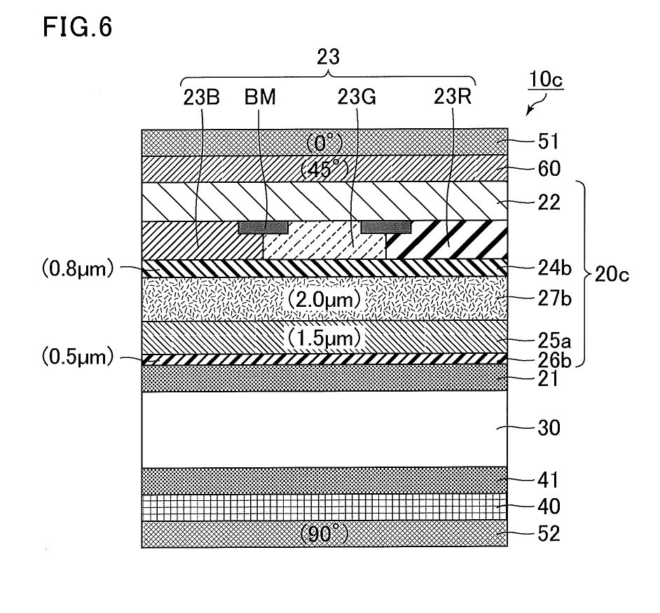

FIG. 6 is a schematic cross-sectional view of a liquid crystal display device of Example 4. As shown in FIG. 6, a liquid crystal display device 10c of Example 4 includes, in the following order from the viewing surface side toward the back surface side, the first polarizing plate 51, the first λ/4 retardation layer (out-cell retardation layer) 60, a color filter substrate 20c, the first alignment film 21, the liquid crystal layer 30, the second alignment film 41, the TFT substrate 40, and the second polarizing plate 52. The color filter substrate 20c includes, in the following order from the viewing surface side toward the back surface side, the supporting substrate 22, the color filter layer 23, a second overcoat layer 24b, the pressure-sensitive adhesive layer 27b, the second λ/4 retardation layer (in-cell retardation layer) 25a, and a first overcoat layer 26b.

In Example 4, as in Example 3, a film-type retardation layer is used as the in-cell retardation layer 25a, and is bonded to the second overcoat layer 24b via the pressure-sensitive adhesive layer 27b. The second overcoat layer 24b and the first overcoat layer 26b have smaller thicknesses than the second overcoat layer 24a and the first overcoat layer 26a in Example 3, respectively. The second overcoat layer 24b had a thickness of 0.8 μm. The first overcoat layer 26b had a thickness of 0.5 μm.

### Example 5

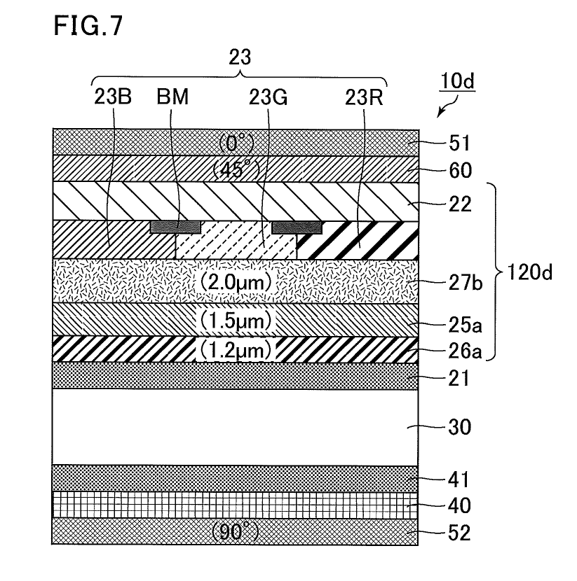

FIG. 7 is a schematic cross-sectional view of a liquid crystal display device of Example 5. As shown in FIG. 7, a liquid crystal display device 10d of Example 5 includes, in the following order from the viewing surface side toward the back surface side, the first polarizing plate 51, the first λ/4 retardation layer (out-cell retardation layer) 60, a color filter substrate 120d, the first alignment film 21, the liquid crystal layer 30, the second alignment film 41, the TFT substrate 40, and the second polarizing plate 52. The color filter substrate 120d includes, in the following order from the viewing surface side toward the back surface side, the supporting substrate 22, the color filter layer 23, the pressure-sensitive adhesive layer 27b, the second λ/4 retardation layer (in-cell retardation layer) 25a, and the first overcoat layer 26a.

In Example 5, as in Example 3, a film-type retardation layer is used as the in-cell retardation layer 25a. Yet, unlike in Example 3, the second overcoat layer 24a is not used, and the in-cell retardation layer 25a is bonded to the color filter layer 23 via the pressure-sensitive adhesive layer 27b.

### Example 6

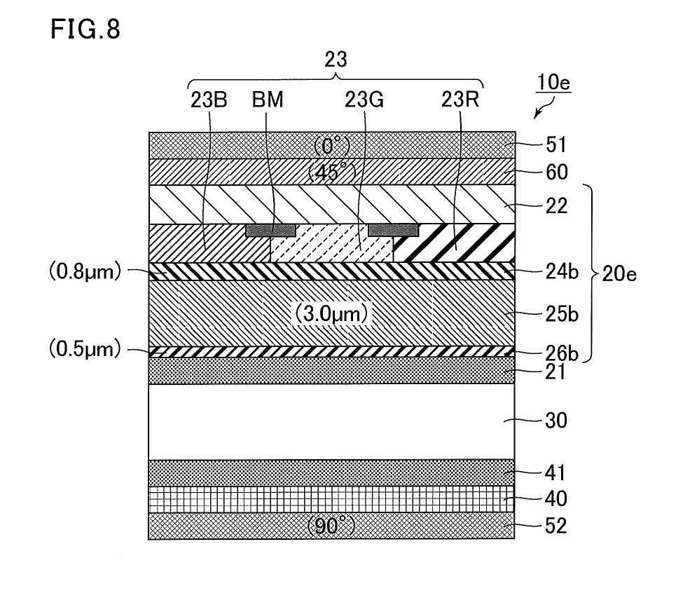

FIG. 8 is a schematic cross-sectional view of a liquid crystal display device of Example 6. As shown in FIG. 8, a liquid crystal display device 10e of Example 6 includes, in the following order from the viewing surface side toward the back surface side, the first polarizing plate 51, the first λ/4 retardation layer (out-cell retardation layer) 60, a color filter substrate 20e, the first alignment film 21, the liquid crystal layer 30, the second alignment film 41, the TFT substrate 40, and the second polarizing plate 52. The color filter substrate 20e includes, in the following order from the viewing surface side toward the back surface side, the supporting substrate 22, the color filter layer 23, the second overcoat layer 24b, a second λ/4 retardation layer (in-cell retardation layer) 25b, and the first overcoat layer 26b.

In Example 6, unlike in Examples 2 to 5, a coating-type retardation layer formed from a photo-polymerizable liquid crystal material is used as the in-cell retardation layer 25b. Formation of the in-cell retardation layer 25b by coating eliminates the need for a pressure-sensitive adhesive layer, achieving thickness reduction as compared with Examples 2 to 5. The in-cell retardation layer 25b had a thickness of 3.0 μm, and the second overcoat layer 24b and the first overcoat layer 26b are thin layers as in Example 4.

### Example 7

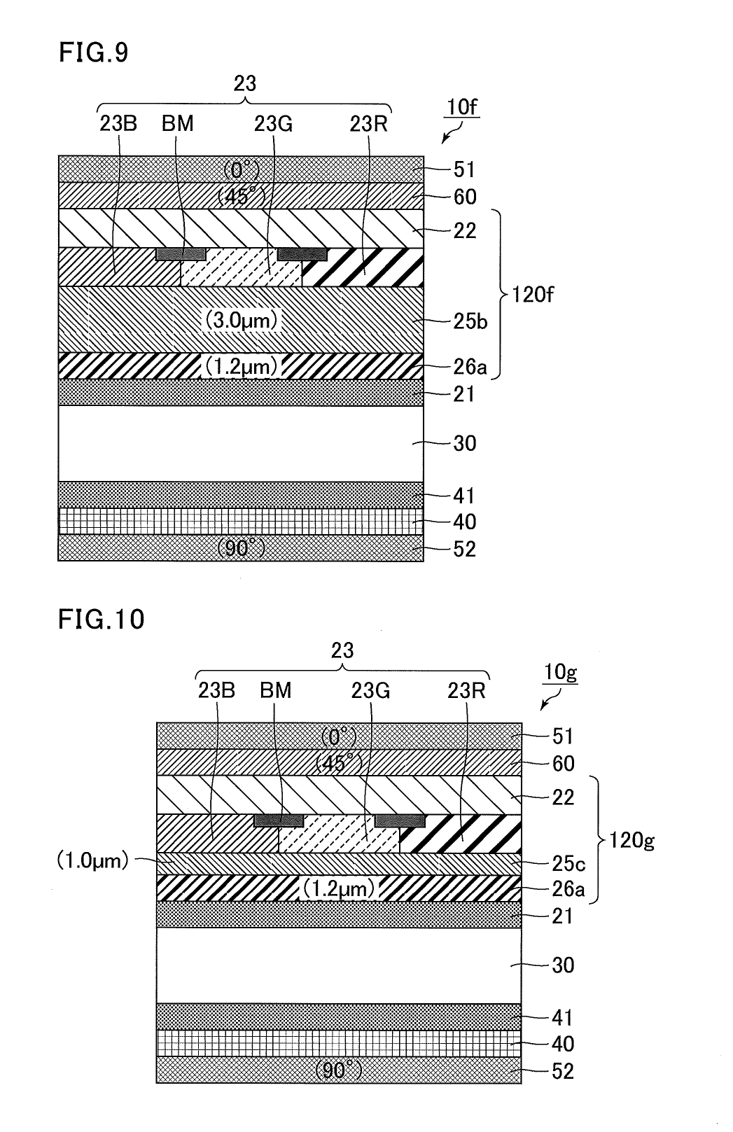

FIG. 9 is a schematic cross-sectional view of a liquid crystal display device of Example 7. As shown in FIG. 9, a liquid crystal display device 10f of Example 7 includes, in the following order from the viewing surface side toward the back surface side, the first polarizing plate 51, the first λ/4 retardation layer (out-cell retardation layer) 60, a color filter substrate 120f, the first alignment film 21, the liquid crystal layer 30, the second alignment film 41, the TFT substrate 40, and the second polarizing plate 52. The color filter substrate 120f includes, in the following order from the viewing surface side toward the back surface side, the supporting substrate 22, the color filter layer 23, the second λ/4 retardation layer (in-cell retardation layer) 25b, and the first overcoat layer 26a.

In Example 7, as in Example 6, a coating-type retardation layer is used as the in-cell retardation layer 25b. Unlike in Example 6, the second overcoat layer 24b is not used, and the in-cell retardation layer 25b covers the color filter layer 23. The first overcoat layer 26a had a thickness of 1.2 μm, which is thicker than the first overcoat layer 26b in Example 6.

### Example 8

FIG. 10 is a schematic cross-sectional view of a liquid crystal display device of Example 8. As shown in FIG. 10, a liquid crystal display device 10g of Example 8 includes, in the following order from the viewing surface side toward the back surface side, the first polarizing plate 51, the first λ/4 retardation layer (out-cell retardation layer) 60, a color filter substrate 120g, the first alignment film 21, the liquid crystal layer 30, the second alignment film 41, the TFT substrate 40, and the second polarizing plate 52. The color filter substrate 120g includes, in the following order from the viewing surface side toward the back surface side, the supporting substrate 22, the color filter layer 23, a second λ/4 retardation layer (in-cell retardation layer) 25c, and the first overcoat layer 26a.

In Example 8, the in-cell retardation layer 25c had a smaller thickness than the in-cell retardation layer 25b in Example 7. The in-cell retardation layer 25c had a thickness of 1.0 μm. In this manner, a coating-type retardation layer can be made thinner than a film-type retardation layer and eliminates the need for a pressure-sensitive adhesive layer. Hence, a coating-type retardation layer is suitable in thickness reduction.

### (Evaluation Results)

The color mixing in an oblique view of the display surface of each of the liquid crystal display devices of Examples 2 to 8 was scored by 10 participants, and the average of the scores was calculated. The participants observed the display surface at left and right positions with the display surface as the center, where the polar angle (angle of incline from the line normal to the display surface) was 60° and the distance from the display surface was 40 cm. The color mixing scores were based on the following criteria. The results are shown in the following Table 1.

| | |
|---|---|
| Color mixing was significantly noticeable. | 3 points |
| Color mixing was noticeable. | 2 points |
| Color mixing was hardly noticeable. | 1 point |
| Color mixing was unobservable. | 0 points |

TABLE 1

| | Example 2 | Example 3 | Example 4 | Example 5 | Example 6 | Example 7 | Example 8 |
|---|---|---|---|---|---|---|---|
| Total thickness (μm) | 7.5 | 5.9 | 4.8 | 4.7 | 4.3 | 4.2 | 2.2 |
| Definition: lower than 300 ppi | 2.2 points | 1.4 points | 1.1 points | 0.9 points | 0.4 points | 0.4 points | 0.1 points |
| Definition: 300 ppi or higher | 2.8 points | 1.9 points | 1.7 points | 1.6 points | 0.7 points | 0.6 points | 0.2 points |

The “total thickness” in Table 1 means the sum of the thicknesses of the layers present between the color filter layer 23 and the first alignment film 21.

The results in Table 1 show that when the total thickness was made smaller than 6.0 μm, color mixing was substantially hardly noticeable (less than 2 points) even in an oblique view. In Examples 6 to 8 where the in-cell retardation layers used were coating-type retardation layers, the total thickness was reduced to smaller than 4.5 μm, and thereby color mixing was substantially unobservable (less than 1 point) even in an oblique view.

### Embodiment 3

The type of spacers used to control the thickness (cell gap) of the liquid crystal layer 30 in the liquid crystal display devices of Embodiments 1 and 2 is not limited. A liquid crystal display device of Embodiment 3 has a structure in which the liquid crystal display device of Embodiment 1 or 2 includes photo spacers. With the first overcoat layer 26 between the second λ/4 retardation layer (in-cell retardation layer) 25 and the first alignment film 21, the liquid crystal display devices of Embodiments 1 and 2 achieve the effect of preventing display defects due to a decrease in the voltage holding ratio. In addition to this effect, the liquid crystal display device of Embodiment 3 can achieve the effect of preventing display unevenness (light leakage). The effect of preventing display unevenness (light leakage) is achieved for the following reason.

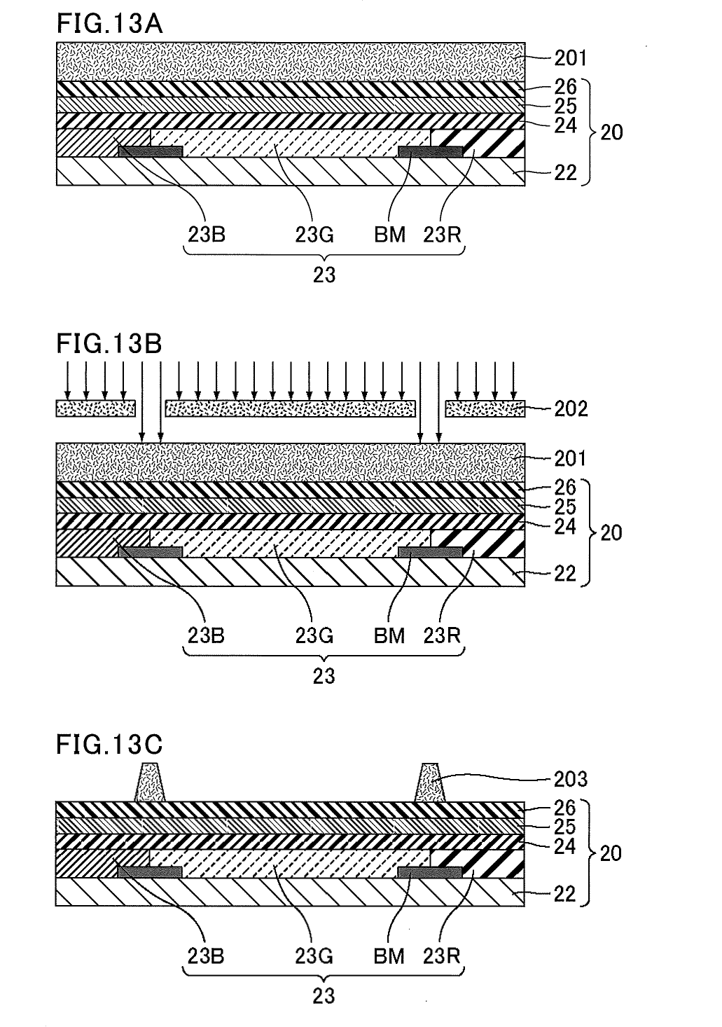

Photo spacers are formed from a cured product a photosensitive material, and can be obtained by, for example, radically copolymerizing a (meth)acrylic acid and another monomer. An exemplary process of forming photo spacers is described with reference to FIGS. 13A, 13B, and 13C. FIG. 13A is a view showing the state where a thin film of a photosensitive material is formed on the first overcoat layer 26. FIG. 13B is a view illustrating how to expose the thin film of a photosensitive material to light. FIG. 13C is a view showing the state where photo spacers are formed on the first overcoat layer 26.

As shown in FIG. 13A, the first overcoat layer of the color filter substrate is coated with a photosensitive material using an applicator such as a slit coater, and the material is pre-baked at 80° C. for three minutes, so that a thin film 201 is formed. The obtained thin film is exposed to light through a mask 202 as shown in FIG. 13B. For the exposure, an exposure device including as a light source a high pressure mercury lamp emitting light with a g-, h-, i, and j-line mixed spectrum. The thin film exposure to light is then developed at 23° C. using a 1/100 dilution of a KOH aqueous solution (developer) containing a surfactant, followed by washing with ultrapure water (rinsing liquid) for 60 seconds. Here, the process may fail to completely wash off the developer, leaving part of the developer adhering to the photo spacers. KOH in the developer, which is strongly alkaline, has an influence on various members, especially a negative influence on the in-cell retardation layer 25. After removal of the rinsing liquid, the thin film is post-baked in a clean oven at 220° C. for 60 minutes, whereby the crosslinking reaction of the photosensitive material is completed. Thereby, as shown in FIG. 13, the photo spacers 203 are formed.

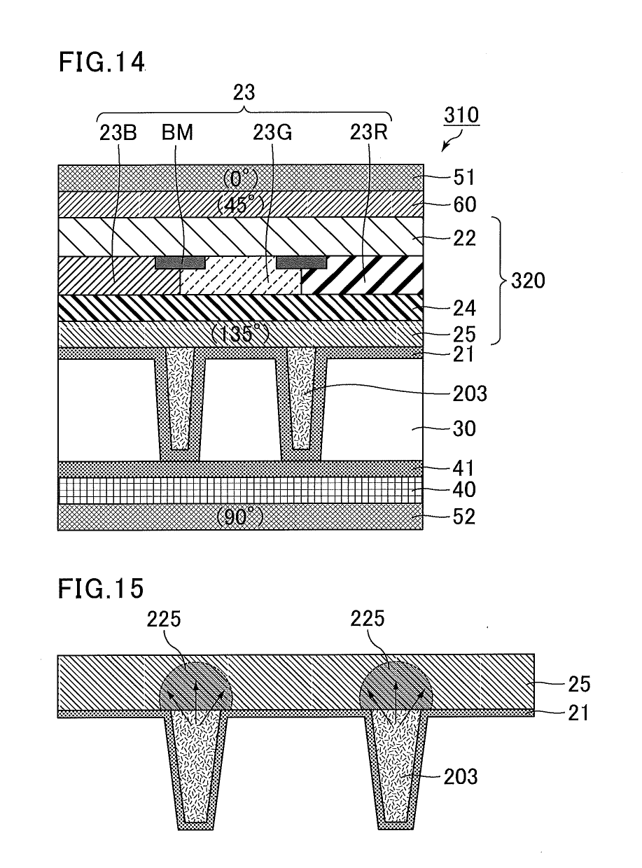

FIG. 14 is a schematic cross-sectional view of a structure in which the liquid crystal display device of Comparative Example 2 includes photo spacers. As shown in FIG. 14, in the case where the liquid crystal display device of Comparative Example 2 includes photo spacers, the in-cell retardation layer 25, the photo spacers 203, and the first alignment film 21 are disposed in the given order. This order, if the developer adheres to the photo spacers 203 as shown in FIG. 15, unfortunately causes the developer to exude into the in-cell retardation layer 25, decreasing the retardation provided by the in-cell retardation layer 25 in developer exudation regions 225. Such a decrease in retardation provided by the in-cell retardation layer 25 near the photo spacers 203 causes display unevenness (light leakage).

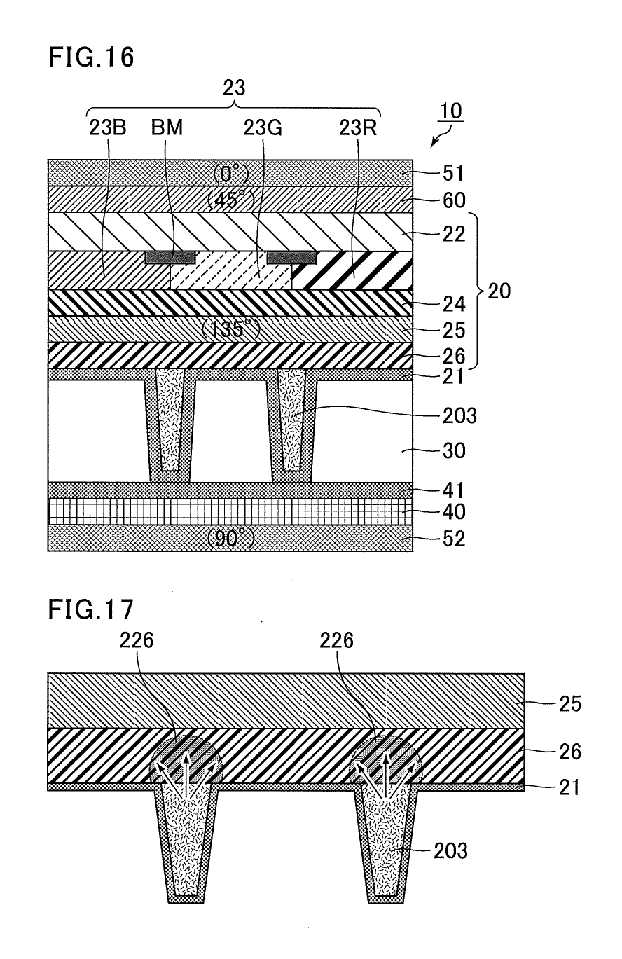

FIG. 16 is a schematic cross-sectional view of a structure in which the liquid crystal display device of Embodiment 1 includes photo spacers. As shown in FIG. 16, in the case where the liquid crystal display device of Embodiment 1 includes photo spacers, the in-cell retardation layer 25, the first overcoat layer 26, the photo spacers 203, and the first alignment film 21 are disposed in the given order (the same applies to the liquid crystal display devices of Embodiments 2, 3, 4, and 6). This order, if the developer adheres to the photo spacers 203 as shown in FIG. 17, causes the developer to exude into the first overcoat layer 26, forming developer exudation regions 226 in the first overcoat layer 26. The developer, however, does not reach the in-cell retardation layer 25. This structure therefore causes no decrease in the retardation provided by the in-cell retardation layer 25 near the photo spacers 203, enabling prevention of display unevenness.

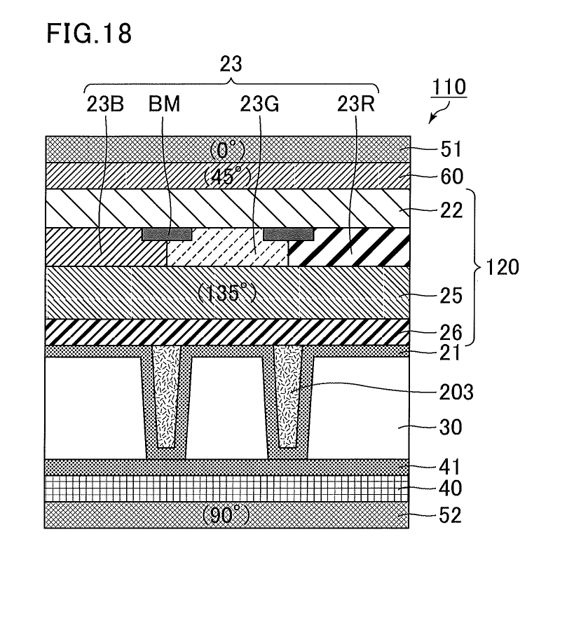

FIG. 18 is a schematic cross-sectional view of a structure in which the liquid crystal display device of Embodiment 2 includes photo spacers. As shown in FIG. 18, also in the case where the liquid crystal display device of Embodiment 2 includes photo spacers, the in-cell retardation layer 25, the first overcoat layer 26, the photo spacers 203, and the first alignment film 21 are disposed in the given order (the same applies to the liquid crystal display devices of Examples 5, 7, and 8). This structure therefore causes no decrease in the retardation provided by the in-cell retardation layer 25 near the photo spacers 203, enabling prevention of display unevenness.

The first overcoat layer 26 preferably has a thickness of 0.5 μm or greater and smaller than 3.0 μm as described above. A greater thickness leads to a higher effect of preventing exudation of the developer, but also leads to a greater distance from the liquid crystal layer 30 to the color filter layer 23, which is likely to cause parallax color mixing.

### [Additional Remarks]

One aspect of the present invention is a liquid crystal display device including, in the following order from a viewing surface side toward a back surface side: a first polarizing plate; a first λ/4 retardation layer; a supporting substrate; a second λ/4 retardation layer; a first overcoat layer; an alignment film; a liquid crystal layer containing liquid crystal molecules horizontally aligned with no voltage applied; a TFT substrate including a pair of electrodes configured to generate a transverse electric field in the liquid crystal layer upon voltage application; and a second polarizing plate.

In the above aspect, the liquid crystal display device may further include a plurality of color filters having different colors between the supporting substrate and the second λ/4 retardation layer. In this case, the liquid crystal display device may have the following structure (1) or (2).

(1) The structure in which the liquid crystal layer further includes a second overcoat layer between the plurality of color filters and the second λ/4 retardation layer, wherein the plurality of color filters and the second overcoat layer are in direct contact with each other.
(2) The structure in which the plurality of color filters and the second λ/4 retardation layer are in direct contact with each other.

The second λ/4 retardation layer may contain a cured product of a photo-polymerizable liquid crystal material.

In the above aspect, the liquid crystal display device may further include a pressure-sensitive adhesive layer adjacent to the viewing surface side of the second λ/4 retardation layer.

In the above aspect, the layers between the plurality of color filters and the alignment film preferably have a total thickness of smaller than 6 μm.

In the above aspect, the liquid crystal display device may further include a photo spacer formed from a cured product of a photosensitive material on a back surface side of the first overcoat layer.

What is claimed is:

1. A liquid crystal display device comprising, in the following order from a viewing surface side toward a back surface side:
a first polarizing plate;
a first λ/4 retardation layer;
a supporting substrate;
a second λ/4 retardation layer;
a first overcoat layer;
an alignment film;
a liquid crystal layer containing liquid crystal molecules horizontally aligned with no voltage applied;
a TFT substrate including a pair of electrodes configured to generate a transverse electric field in the liquid crystal layer upon voltage application; and
a second polarizing plate.

2. The liquid crystal display device according to claim 1, further comprising a plurality of color filters having different colors between the supporting substrate and the second λ/4 retardation layer.

3. The liquid crystal display device according to claim 2, further comprising a second overcoat layer between the plurality of color filters and the second λ/4 retardation layer,
wherein the plurality of color filters and the second overcoat layer are in direct contact with each other.

4. The liquid crystal display device according to claim 2,
wherein the plurality of color filters and the second λ/4 retardation layer are in direct contact with each other.

5. The liquid crystal display device according to claim 1,
wherein the second λ/4 retardation layer comprises a cured product of a photo-polymerizable liquid crystal material.

6. The liquid crystal display device according to claim 1, further comprising an adhesive layer adjacent to the viewing surface side of the second λ/4 retardation layer.

7. The liquid crystal display device according to claim 2,
wherein the layers between the plurality of color filters and the alignment film have a total thickness of smaller than 6 μm.

8. The liquid crystal display device according to claim 1, further comprising a photo spacer formed from a cured product of a photosensitive material on a back surface side of the first overcoat layer.
